(19) United States
(12) Patent Application Publication
(10) Pub. No.: US 2013/0314252 A1
(43) Pub. Date: Nov. 28, 2013

(54) IN-VEHICLE PRESENTATION OF INFORMATION ASSOCIATED WITH A SIGN

(71) Applicant: LEIGH M. ROTHSCHILD, SUNNY ISLES BEACH, FL (US)

(72) Inventor: LEIGH M. ROTHSCHILD, SUNNY ISLES BEACH, FL (US)

(73) Assignee: SAMANTHA INVENTIONS, LLC, BAY HARBOUR, FL (US)

(21) Appl. No.: 13/478,657

(22) Filed: May 23, 2012

(51) Int. Cl. G08G 1/0967

(52) U.S. Cl. 340/905

(57) ABSTRACT

Presenting information within a vehicle. Via an information capture device, a symbolic code or a wireless signal transmitted by a sign located external to the vehicle can be detected. Via an information presentation device located within the vehicle, information associated with the symbolic code or contained in the wireless signal can be presented to an occupant of the vehicle.

### BACKGROUND

Road signs usually are posted along roadways to visually present various types of information to drivers, such as road identifications, maximum and/or minimum speed limits, caution warnings, and points of interest. Oftentimes lighted displays also are posted along roadways to present additional information to drivers, such as current traffic conditions, alerts, and the like. Billboards also are posted along many roadways to present advertisements to drivers.

Sometimes, reading the road signs, displays and/or billboards can be distracting to drivers, especially those drivers whose eyesight is less than perfect. While attempting to read the road signs/displays/billboards, drivers may temporarily lose focus on the task of driving the vehicle, which may increase the risk of the driver being involved in a traffic accident. Also, it may be difficult to read road signs and displays depending on the speed of the vehicle, and the clear line of sight to the sign/display/billboard.

### BRIEF SUMMARY

One or more embodiments disclosed within this specification relate to a method of presenting information within a vehicle. In one arrangement, the method can include, via an information capture device, detecting a symbolic code associated with a sign located external to the vehicle. The method further can include, via an information presentation device located within the vehicle, presenting to an occupant of the vehicle information associated with the symbolic code.

In another arrangement, the method can include via an information capture device, detecting a wireless signal transmitted by a sign located external to the vehicle. The method further can include via an information presentation device located within the vehicle, presenting to an occupant of the vehicle information contained in the wireless signal.

Another embodiment can include an information system. The information system can include an information capture device that detects a symbolic code associated with a sign located external to a vehicle, and an information presentation device located within the vehicle that presents to an occupant of the vehicle information associated with the symbolic code.

In another arrangement, the information system can include an information capture device that detects a wireless signal transmitted by a sign located external to a vehicle, and an information presentation device located within the vehicle that presents to an occupant of the vehicle information contained in the wireless signal.

Another embodiment can include a computer program product for presenting information within a vehicle. The computer program product can include a computer readable storage medium having stored thereon program code that, when executed, configures a processor to perform various executable operations and/or functions disclosed within this specification.

### BRIEF DESCRIPTION OF THE SEVERAL VIEWS OF THE DRAWINGS

FIG. 1 is a view of a vehicle in accordance with one embodiment disclosed within this specification.

FIG. 2 is block diagram of an information system in accordance with one embodiment disclosed within this specification.

FIG. 3 is a flow chart illustrating a method of presenting information within a vehicle in accordance with one embodiment disclosed within this specification.

FIG. 4 is a flow chart illustrating a method of presenting information within a vehicle in accordance with another embodiment disclosed within this specification.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

In accordance with the arrangements described herein, an information capture and presentation system (hereinafter “information system”) can be incorporated into a vehicle to capture information presented by road signs, water navigation signs, aircraft navigation signs, roadside displays and/or billboards (hereinafter collectively referred to as “signs”) and present such information to one or more occupants of the vehicle. Accordingly, the information can be presented to the occupants of the vehicle without the need for the occupants to read the sign.

In one aspect, the information system can present the information as one or more images or video on a display located within the vehicle, such as a heads-up display or display panel. In another aspect, the information system can present the information as one or more audio signals generated within the vehicle, for example via the vehicles audio system or infotainment system. In yet another aspect, the information can be presented on a mobile communication device within the vehicle, as will be described.

In one aspect, the information can be presented as one or more symbolic codes presented on or near the signs, and the information system can read and interpret the symbolic codes. As used herein, a “symbolic code” is an optical machine-readable representation of data, which shows data about the object with which the symbolic code is associated. In one embodiment, a symbolic code can represent data using a plurality of parallel lines of varying widths and/or varying spacing between the lines, which may be referred to as linear or one-dimensional (1D) barcode. The invention is not limited in this regard, however. For instance, a barcode can be represented by one or more rectangles, dots, hexagons and/or other geometric patterns in two dimensions, which may be referred to as a two-dimensional (2D) bar code. An example of a 2D barcode is a matrix barcode, such as a Quick Response Code (QR Code®), or a Microsoft® Tag code. Still, any other symbolic codes can be used and the present arrangements are not limited in this regard.

In another aspect, the information system can be presented as infrared (IR) signals associated with the signs (e.g., emanated from the signs or devices proximate to the signs), and the information system can detect and interpret the IR signals. In yet another arrangement, the information system can be presented as radio frequency (RF) signals associated with the signs, and the information system can detect and interpret the RF signals.

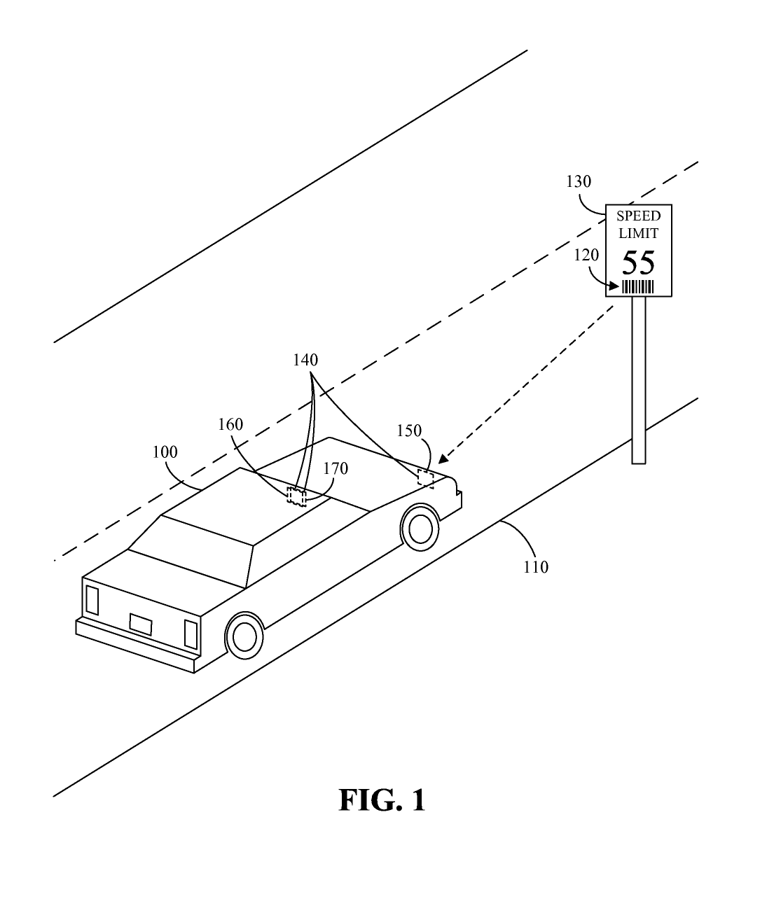

FIG. 1 is a view of a vehicle 100 in accordance with one embodiment disclosed within this specification. The vehicle 100 can be implemented an automobile, a truck, a tractor, farming equipment, a boat, an aircraft, a forklift or the like. In an example in which the vehicle 100 is an automobile, a truck, a tractor or farming equipment, the vehicle can travel on a roadway 110 and the sign can be a road sign, billboard and/or roadside display. In an example, in which the vehicle 100 is a boat, the vehicle can navigate on a waterway and the sign can be a water navigation sign. In an example in which the vehicle 100 is an aircraft, the vehicle can travel on a taxiway or runway of an airport and the sign can be an aircraft navigation sign. In an example in which the vehicle is a forklift, the vehicle 100 can travel within a building, for example in an aisle, or travel outside of a building, for example on a shipping dock, and the sign can be a sign that presents information related to forklift operation.

In one example, while the vehicle 100 is traveling (e.g., moving on the roadway 110 or stopped on the roadway 110), an information system 140 of the vehicle can detect one or more symbolic codes 120 associated with a sign 130 located external to the vehicle, or wireless signals (e.g., IR signals and/or RF signals) transmitted by a sign 130 located external to the vehicle, and present corresponding information to one or more occupants of the vehicle 100. The information system 140 can be integrated into the vehicle 100, attached to the vehicle 100 in a suitable manner, or otherwise suitable placed within the vehicle 100. In an arrangement in which the sign 130 transmits wireless signals, the sign 130 can include a transmitter or transceiver. The transmitter/transceiver can be attached to the sign in a suitable manner, or embedded within the sign.

The information system 140 can include an information capture device (or system) 150 that detects the symbolic codes 120 or wireless signals. In one arrangement, the information capture device 150 can include one or more imaging devices that capture an image of the symbolic code 120 and identify information corresponding to the symbolic code 120. For example, the information capture device 150 can include an array of one or more charge-coupled devices (CCDs) or complementary metal-oxide-semiconductor (CMOS) sensors configured to detect symbolic codes. The information capture device 150 can identify signs located outside of the vehicle while the vehicle is traveling, and identify symbolic code on or near the signs. When the information capture device 150 identifies symbolic code, the information capture device 150 can capture an image of the symbolic code and process the image to identify information represented by the symbolic code.

In another arrangement, the information capture device 150 can include an IR receiver that receives the IR signal and demodulates the IR signal to identify information contained in the IR signal. In yet another arrangement, the information capture device 150 can include an RF receiver that receives the RF signal and demodulates the RF signal to identify information contained in the RF signal. The information capture device 150 can be located at a front of the vehicle 100, attached to a surface of the vehicle 100, located proximate to a window (e.g., front windshield or side window) of the vehicle 100, held by an occupant of the vehicle 100, or placed elsewhere within the vehicle 100.

The information system 140 also can include an information presentation device (or system) 160 that receives the identified information from the information capture device 150, and presents the information to one or more occupants of the vehicle 100. In illustration, the information presentation device 160 can be a display that visually presents the information within a gauge cluster or infotainment system of the vehicle, or in presents the information in a heads-up display projected on a windshield of the vehicle. The information presentation device 160 also can be an audio system that audibly presents the information via a dedicated output audio transducer or the vehicle's audio system (e.g., stereo system). The information presentation device 160 also can be a mobile communication device, such as a smart phone, tablet computer, mobile computer, laptop computer, etc. located within the vehicle 100.

The information presentation device 160 can receive the information captured by the information capture device 150 via a wired communication link and/or a wireless communication link. Examples of suitable wireless communication links include, but are not limited to, wireless communication links implemented in accordance with a suitable networking protocol (e.g., WiFi®), wireless communication links implemented in accordance with a personal area network (PAN) protocol (e.g., Bluetooth® or ZigBee®), wireless communication links implemented in accordance with a suitable direct wireless communication protocol, wireless communication links implemented in accordance with a suitable infrared (IR) communication protocol, or wireless communication links implemented in accordance with any other suitable protocol.

Further, the information detected by the information capture device 150 can indicate a resource, such as a uniform resource identifier (URI), from which additional information may be accessed. In one arrangement, the URI can be a uniform resource locator (URL). In illustration, the sign 130 can be a billboard advertising a particular product or service, or a road sign or navigation sign that indicates nearby services and/or establishments. In such cases, the symbolic code 120 or wireless signal can indicate one or more URIs associated with such services and/or establishments. The information system 140 can include a web client 170 that receives the information detected by the information capture device 150 and accesses the URI(s) identified in the information. The web client 170 can include software and/or hardware for wirelessly accessing the Internet, or another suitable communication network, for example using a cellular communication link, WiFi®, or any other suitable communication protocol.

By way of example, when the information indicates one or more URIs, the information system 140 can indicate a list of the URIs via the information presentation device 160, and provide an occupant of the vehicle an option to select one or more of the URIs to view the corresponding web pages, or listen to audio presented by the corresponding web pages. For instance, in an arrangement in which the information presentation device 160 comprises a touch screen, the information system 140 can present an indicator for each service and/or establishment indicated by the symbolic code 120 or wireless signal. Responsive to an occupant of the vehicle selecting one of the indicators, the information system 140 can access a corresponding website and present information from the website on the touchscreen and/or through an audio system. In another example, the information system 140 can audibly present a list of the indicators through an audio system, and prompt the vehicle occupant to select one or more of the indicators via a spoken utterance. Responsive to the occupant selecting an indicator, either by a spoken utterance or a selection via the touchscreen, the information system 140 can access a corresponding website and present information from the website on the display and/or through the audio system.

The web client 170 can be communicatively linked to the information capture device 150 and/or the information presentation device 160 via a wired or wireless communication link, such as a wireless communication link previously described. Further, the web client 170 can include, or otherwise access, a transceiver coupled to an antenna to wirelessly connect to the Internet or other communication network. For example, the web client 170 can communicatively link to a mobile communication device.

In one non-limiting example, information system 140 can be a single device or unit that includes both the information capture device 150 and the information presentation device 160 and, optionally, the web client 170. For example, the information system 140 can be a device that attaches to the vehicle's windshield or dashboard, includes an image capture device, IR receiver and/or RF receiver, and includes a display and/or audio output transducer to present the information to the vehicle's occupants. The information system 140 also can include a transceiver and hardware/software that communicatively links the information system 140 to a communication network, such as the Internet.

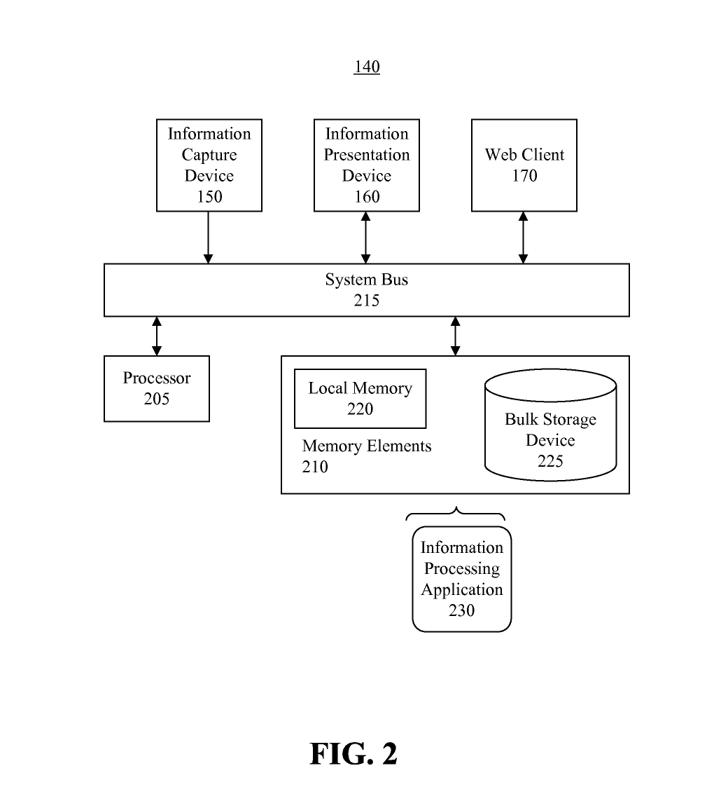

FIG. 2 is diagram of an information system 140 in accordance with one embodiment disclosed within this specification. The information system 140 can include at least one processor 205 coupled to memory elements 210 through a system bus 215 or other suitable circuitry. As such, the information system 200 can store program code within memory elements 210. The processor 205 can execute the program code accessed from the memory elements 210 via the system bus 215. In one aspect, for example, the information system 140 can be implemented as a computer that is suitable for storing and/or executing program code. It should be appreciated, however, that the information system 140 can be implemented in the form of any system including a processor and memory that is capable of performing the functions and/or operations described within this specification.

The memory elements 210 can include one or more computer-readable storage devices 210 such as, for example, local memory 220 and one or more bulk storage devices 225. Local memory 220 refers to random access memory or other non-persistent memory device(s) generally used during actual execution of the program code. The bulk storage device(s) 225 can be implemented as non-transitory computer readable storage devices read only memory (ROM), a hard disk drive (HDD), a solid state drive (SSD) or other persistent data storage device, an erasable programmable read-only memory (EPROM or Flash memory), a portable compact disc read-only memory (CD-ROM), a digital versatile disc (DVD), an optical storage device, a magnetic storage device, or any suitable combination of the foregoing. The information system 200 also can include one or more cache memories (not shown) that provide temporary storage of at least some program code in order to reduce the number of times program code must be retrieved from the bulk storage device 225 during execution. In the context of this document, a computer-readable storage device may be any tangible medium that can contain, or store a program for use by or in connection with an instruction execution system, apparatus, or device.

As noted, the information system 140 can include the information capture device (or system) 150, the information presentation device (or system) 160 and, optionally, the web client 170. The information capture device 150, information presentation device 160 and web client 170 can be coupled to the processor 205 directly via the system bus 215 or through intervening input/output (I/O) controllers via wired and/or wireless communication links. In one embodiment, the processor 205, memory elements 210 and system bus 215 can be components of a device or system to which the information capture device 150 information presentation device 160 and web client 170 are communicatively linked. In another embodiment, the processor 205, memory elements 210 and system bus 215 can be components of the information capture device 150. In another embodiment, processor 205, memory elements 210 and system bus 215 can be components of the information presentation device 160. In another embodiment, processor 205, memory elements 210 and system bus 215 can be components of the web client 170. In yet another embodiment, the processor 205, memory elements 210 system bus 215, information capture device 150, information presentation device 160 and web client 170 can be components of a single device or system.

As pictured in FIG. 2, the memory elements 210 can store an information processing application 230. The information processing application 230, being implemented in the form of computer-readable program code, can be executed by the information system 140 and, as such, can be considered part of the information system 140. In this regard, the information processing application 230 can be executed by the processor 205 to perform executable operations for the methods and processes described herein.

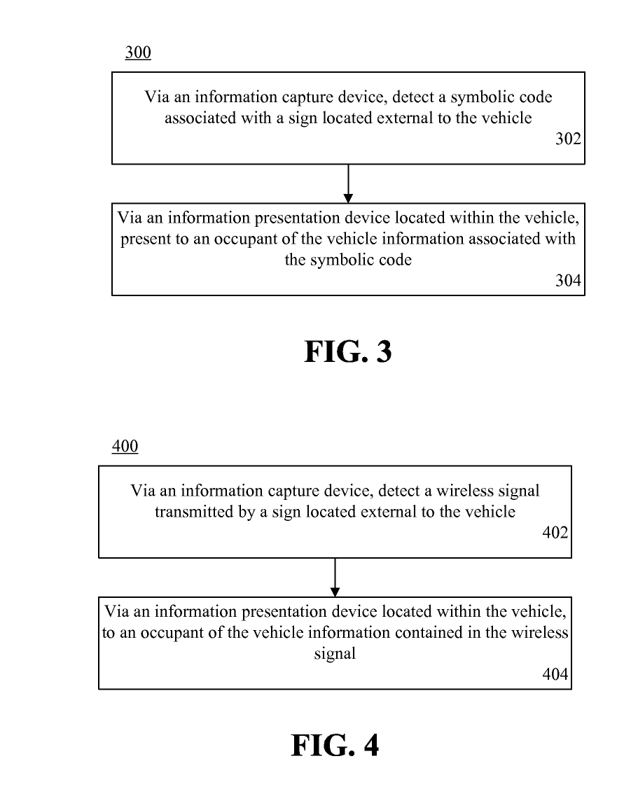

FIG. 3 is a flow chart illustrating a method 300 of presenting information within a vehicle in accordance with one embodiment disclosed within this specification. At step 302, via an information capture device, a symbolic code associated with a sign located external to the vehicle can be detected. At step 304, via an information presentation device located within the vehicle, information associated with the symbolic code can be presented to an occupant of the vehicle.

FIG. 4 is a flow chart illustrating a method 400 of presenting information within a vehicle in accordance with another embodiment disclosed within this specification. At step 402, via an information capture device, a wireless signal transmitted by a sign located external to the vehicle can be detected. At step 404, via an information presentation device located within the vehicle, information contained in the wireless signal can be presented to an occupant of the vehicle.

Like numbers have been used to refer to the same items throughout this specification. The flowcharts and block diagrams in the Figures illustrate the architecture, functionality, and operation of possible implementations of systems, methods and computer program products according to various embodiments of the present invention. In this regard, each block in the flowcharts may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of presenting information within a vehicle, the method comprising:
via an information capture device, detecting a symbolic code associated with a sign located external to the vehicle; and
via an information presentation device located within the vehicle, presenting to an occupant of the vehicle information associated with the symbolic code.

2. The method of claim 1, wherein:
the vehicle is an automobile traveling on a roadway; and
the sign is a road sign, billboard or roadside display.

3. The method of claim 1, wherein:
the vehicle is a boat navigating a waterway; and
the sign is a water navigation sign.

4. The method of claim 1, wherein:
the vehicle is an aircraft traveling on a taxiway or runway; and
the sign is an aircraft navigation sign.

5. The method of claim 1, wherein:
the vehicle is a forklift; and
the sign presents information related to forklift operation.

6. The method of claim 1, wherein:
the information associated with the symbolic code comprises at least one uniform resource identifier (URI);
the method further comprising:
receiving from the occupant of the vehicle a selection of the URI;
responsive to the user selection, accessing a website corresponding to the URI; and
presenting information from the website to the occupant of the vehicle.

7. A method of presenting information within a vehicle, the method comprising:
via an information capture device, detecting a wireless signal transmitted by a sign located external to the vehicle; and
via an information presentation device located within the vehicle, presenting to an occupant of the vehicle information contained in the wireless signal.

8. The method of claim 7, wherein:
the vehicle is an automobile traveling on a roadway; and
the sign is a road sign, billboard or roadside display.

9. The method of claim 7, wherein:
the vehicle is a boat navigating a waterway; and
the sign is a water navigation sign.

10. The method of claim 7, wherein:
the vehicle is an aircraft traveling on a taxiway or runway; and
the sign is an aircraft navigation sign.

11. The method of claim 7, wherein:
the vehicle is a forklift; and
the sign presents information related to forklift operation.

12. The method of claim 7, wherein:
the information contained in the wireless signal comprises at least one uniform resource identifier (URI);
the method further comprising:
receiving from the occupant of the vehicle a selection of the URI;
responsive to the user selection, accessing a website corresponding to the URI; and
presenting information from the website to the occupant of the vehicle.

13. An information system comprising:
an information capture device that detects a symbolic code associated with a sign located external to a vehicle; and
an information presentation device located within the vehicle that presents to an occupant of the vehicle information associated with the symbolic code.

14. The information system of claim 13, wherein:
the vehicle is an automobile traveling on a roadway; and
the sign is a road sign, billboard or roadside display.

15. The information system of claim 13, wherein:
the vehicle is a boat navigating a waterway; and
the sign is a water navigation sign.

16. The information system of claim 13, wherein:
the vehicle is an aircraft traveling on a taxiway or runway; and
the sign is an aircraft navigation sign.

17. The information system of claim 13, wherein:
the vehicle is a forklift; and
the sign presents information related to forklift operation.

18. The information system of claim 13, wherein:
the information associated with the symbolic code comprises at least one uniform resource identifier (URI);
the information system receives from the occupant of the vehicle a selection of the URI;
responsive to the user selection, the information system accesses a website corresponding to the URI; and
the information presentation device presents information from the website to the occupant of the vehicle.

19. An information system comprising:
an information capture device that detects a wireless signal transmitted by a sign located external to a vehicle; and
an information presentation device located within the vehicle that presents to an occupant of the vehicle information contained in the wireless signal.

20. The information system of claim 19, wherein:
the vehicle is an automobile traveling on a roadway; and
the sign is a road sign, billboard or roadside display.

21. The information system of claim 19, wherein:
the vehicle is a boat navigating a waterway; and
the sign is a water navigation sign.

22. The information system of claim 19, wherein:
the vehicle is an aircraft traveling on a taxiway or runway; and
the sign is an aircraft navigation sign.

23. The information system of claim 19, wherein:
the vehicle is a forklift; and
the sign presents information related to forklift operation.

24. The information system of claim 19, wherein:
the information associated with the symbolic code comprises at least one uniform resource identifier (URI);
the information system receives from the occupant of the vehicle a selection of the URI;
responsive to the user selection, the information system accesses a website corresponding to the URI; and
the information presentation device presents information from the website to the occupant of the vehicle.

25. A computer program product for presenting information within a vehicle, said computer program product comprising:
a computer readable storage medium having stored thereon program code that, when executed, configures a processor to perform executable operations comprising:
detecting a symbolic code associated with a sign located external to the vehicle; and
presenting to an occupant of the vehicle information associated with the symbolic code.

26. A computer program product for presenting information within a vehicle, said computer program product comprising:
a computer readable storage medium having stored thereon program code that, when executed, configures a processor to perform executable operations comprising:
detecting a wireless signal transmitted by a sign located external to the vehicle; and
presenting to an occupant of the vehicle information contained in the wireless signal.
